(19) United States
(12) Patent Application Publication
(10) Pub. No.: US 2017/0258066 A1
(43) Pub. Date: Sep. 14, 2017

(54) Customized Ungulate Foot Protection Devices and Related Assemblies and Methods

(71) Applicant: D2M Solutions FZE, Dubai (AE)

(72) Inventors: Robert J. Stevenson, Queensland (AU); Dimitrios H. Nicolaides, Dubai (AE)

(21) Appl. No.: 15/368,415

(22) Filed: Dec. 2, 2016

Related U.S. Application Data
(60) Provisional application No. 62/305,763, filed on Mar. 9, 2016.

(51) Int. Cl. A01L 3/00; B29C 33/38; B29C 33/40; A01L 15/00; B33Y 50/02; B33Y 80/00; A01L 7/00; B29C 67/00; B33Y 10/00

(52) U.S. Cl. CPC A01L 3/00; B29C 67/0088; B29C 33/3842; B29C 33/40; B33Y 10/00; B33Y 50/02; B33Y 80/00; A01L 7/00; A01L 15/00; B29K 2083/00

(57) ABSTRACT

This disclosure includes customized ungulate foot protection devices and related methods. Some methods of protecting an ungulate foot include capturing a three-dimensional image of a portion of the ungulate foot, producing a three-dimensional image of an overmold, wherein the overmold includes a cavity that is complementary in shape to the captured three-dimensional image of the portion of the ungulate foot, assembling a three-dimensional image of a protective shoe element with the three-dimensional image of the overmold, and manufacturing the assembled three-dimensional images of the protective shoe element and the overmold. Some methods comprise coupling the manufactured overmold to the ungulate foot.

### CROSS-REFERENCE TO RELATED APPLICATION

This application claims priority to U.S. Provisional Application No. 62/305,763, filed Mar. 9, 2016 and entitled “UNGULATE FOOT PROTECTION DEVICES AND METHODS,” the entire of content of which is incorporated herein by reference.

### BACKGROUND

1. Field of Invention

The present invention relates generally to terrestrial ungulate foot protection, and more specifically, but not by way of limitation, to customized ungulate foot protection devices and related methods.

2. Description of Related Art

Most terrestrial ungulates use the tips of their toes, usually hoofed, to sustain their whole body weight while moving. Ungulate generally means, “being hoofed” or “hoofed animal”. Horses, camels, and bovinae, such as domestic cattle and/or the like are all members of this diverse clade of primarily large mammals. Domesticated horses, camels, and bovinae that walk on man-made and other hard surfaces often require some form of foot protection. Additionally, they may develop foot conditions, such as laminitis, from exercise, injury, traction, performance enhancement, and birth deformity, which also necessitate the application of some form of foot protection. Commercially available foot protection, such as commercially available horseshoes and the like, are often unable to accommodate the wide range of variation found between ungulate feet. Furthermore, applying foot protection to animals with foot conditions can be uncomfortable or traumatic to the animal and owner.

Therefore a need exists for novel customized ungulate foot protection devices and methods. There is also a need for novel methods of making an in situ horseshoe and hoof protection devices. A further need exists, for novel ungulate foot protection devices and methods which are able to provide a horseshoe or other foot protection mold and attachment to an ungulate foot without the use of nails or adhesives. Finally, a need exists for novel ungulate foot protection devices and methods which are able to produce an attached horseshoe or foot protection that is lighter and more flexible than traditional steel or aluminum horseshoes.

### SUMMARY

Some embodiments of the present methods of protecting an ungulate foot comprise: capturing a three-dimensional image of a portion of the ungulate foot; producing a three-dimensional image of an overmold, wherein the overmold includes a cavity that is complementary in shape to the captured three-dimensional image of the portion of the ungulate foot; assembling a three-dimensional image of a protective shoe element with the three-dimensional image of the overmold; and manufacturing the assembled three-dimensional images of the protective shoe element and the overmold. Some methods further comprise coupling the manufactured overmold to the ungulate foot.

Some methods further comprise manufacturing the assembled three-dimensional images of the protective shoe element and the overmold includes converting the assembled three-dimensional images into physical form by additive manufacturing.

In some methods, capturing the three-dimensional image of the portion of the ungulate foot includes scanning the portion of the ungulate foot in three dimensions. In some methods, the three-dimensional image of the portion of the ungulate foot is captured by a three-dimensional (e.g., laser) scanner.

Some methods further comprise injecting a substance into the cavity of the manufactured overmold, wherein the substance can comprise a thermosetting polymer and/or a polyurethane resin.

In some methods, after coupling the manufactured overmold to the ungulate foot, the substance is injected into the cavity of the manufactured overmold.

Some embodiments of the present methods of protecting an ungulate foot comprise: capturing a three-dimensional image of a portion of the ungulate foot; producing a three-dimensional image of a mold pattern, wherein the mold pattern includes a surface that corresponds in shape to the captured three-dimensional image of the portion of the ungulate foot; manufacturing the three-dimensional image of the mold pattern; disposing the manufactured mold pattern into a casing; and providing a molding material having silicone between the manufactured mold pattern and the casing, wherein the molding material includes properties such that, after a first amount of time, the molding material is capable of hardening into a solid mold that replicates a volume between the manufactured mold pattern and the casing. Some methods further comprise coupling the mold to the ungulate foot. Some methods further comprise injecting a protective material between the mold and the ungulate foot. Some methods further comprise removing the mold from the ungulate foot.

In some methods, the protective material is injected through one or more apertures extending through the mold. In some methods, the protective material includes a topical medication.

Some methods further comprise degassing the molding material before providing the molding material between the manufactured mold pattern and the casing. Some methods further comprise degassing the molding material after providing the molding material between the manufactured mold pattern and the casing. In some methods, the molding material is degassed by a vacuum casting machine.

In some methods, manufacturing the three-dimensional image of the mold pattern includes converting the three-dimensional image into physical form by additive and/or subtractive manufacturing. In some methods, at least a portion of the mold is translucent. In some methods, the mold is flexible.

Some assemblies for producing the present ungulate foot protection devices comprise: a casing having a sidewall and a bottom wall that cooperate to define a cavity; a mold pattern that is configured to be removably disposed within the cavity of the casing, wherein the mold pattern includes a surface that is configured to correspond in shape to a portion of an ungulate foot. Some assemblies further comprise a molding material configured to be disposed in the cavity between the casing and the mold pattern.

An ungulate foot protection device is provided. In some embodiments, the device may comprise a foot receiving element coupled to a shoe element. The foot receiving element may be configured to receive and be coupled to the foot of an animal. The shoe element may comprise one or more ground contacting surfaces and may be configured to contact the ground surfaces over which an animal wearing the device is to move. The foot receiving element may comprise an overmold of the foot of the animal which is complementary in shape to portions of the foot of the animal thereby allowing all or portions of the foot to be received in the foot receiving element. Once the foot is positioned in the foot receiving element, all or portions of the foot may be coupled to the foot receiving element.

According to another embodiment consistent with the principles of the invention, an ungulate foot protection method is provided. In some embodiments, the method may be used to provide foot protection to an ungulate by forming an ungulate foot protection device comprising a foot receiving element and a shoe element, and the method may comprise the steps of: scanning the foot of the ungulate; creating a three-dimensional (3D) image overmold of the ungulate foot; positioning a shoe element on the overmold of foot image; converting the image of overmold with shoe element to a physical copy of an ungulate foot protection device comprising a foot receiving element and a shoe element; and coupling the physical copy of the ungulate foot protection device to the animal foot.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the term “substantially” may be substituted with “within [a percentage] of” what is specified, where the percentage includes 0.1, 1, 5, and 10 percent.

The phrase “and/or” means and or or. The phrase “and/or” includes any and all combinations of one or more of the associated listed items. To illustrate, A, B, and/or C includes: A alone, B alone, C alone, a combination of A and B, a combination of A and C, a combination of B and C, or a combination of A, B, and C. In other words, “and/or” operates as an inclusive or.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

Any embodiment of any of the apparatuses, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Further, an apparatus that is configured in a certain way is configured in at least that way, but it can also be configured in other ways than those specifically described.

Some details associated with the embodiments are described above, and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiment depicted in the figures.

FIG. 1 is a first perspective view of a first embodiment of the present ungulate foot protection devices.

FIG. 2 is a second perspective view of the protection device of FIG. 1.

FIG. 3 shows a perspective view of a device for digitally recording an image of an ungulate foot.

FIGS. 4 and 5 are bottom and perspective views, respectively, of a three-dimensional image of an overmold that may be suitable for use with some embodiments of the present protective devices.

FIG. 6 is a perspective view of an ungulate foot that may be fitted with some embodiments of the present protective devices.

FIG. 7 is a perspective view of the protective device of FIG. 1 coupled to the ungulate foot of FIG. 6.

FIG. 8 is a conceptual flowchart showing a first embodiment of the present methods for protecting an ungulate foot using some embodiments of the present protection devices.

FIG. 9 is a perspective view of a second embodiment of the present ungulate foot protection devices.

FIG. 10 is a bottom view of the protection device of FIG. 9.

FIGS. 11-13 are first perspective, second perspective, and bottom views, respectively, of a mold that may be suitable for use with some embodiments of the present protective devices.

FIG. 14 is a perspective view of an assembly that may be suitable for use with some embodiments of the present protective devices.

FIGS. 15 and 16 are first and second perspective views, respectively, of a casing that may be suitable for use with the assembly of FIG. 14.

FIGS. 17 and 18 are first and second perspective views, respectively, of a mold pattern that may be suitable for use with the assembly of FIG. 14.

FIGS. 19 and 20 are first and second side views, respectively, of the mold pattern of FIGS. 17 and 18.

FIGS. 21-23 are bottom, third, and fourth perspective views, respectively, of the mold pattern of FIGS. 17 and 18.

FIG. 24 is a conceptual flowchart showing a second embodiment of the present methods for protecting an ungulate foot using some embodiments of the present protection devices.

### DETAILED DESCRIPTION

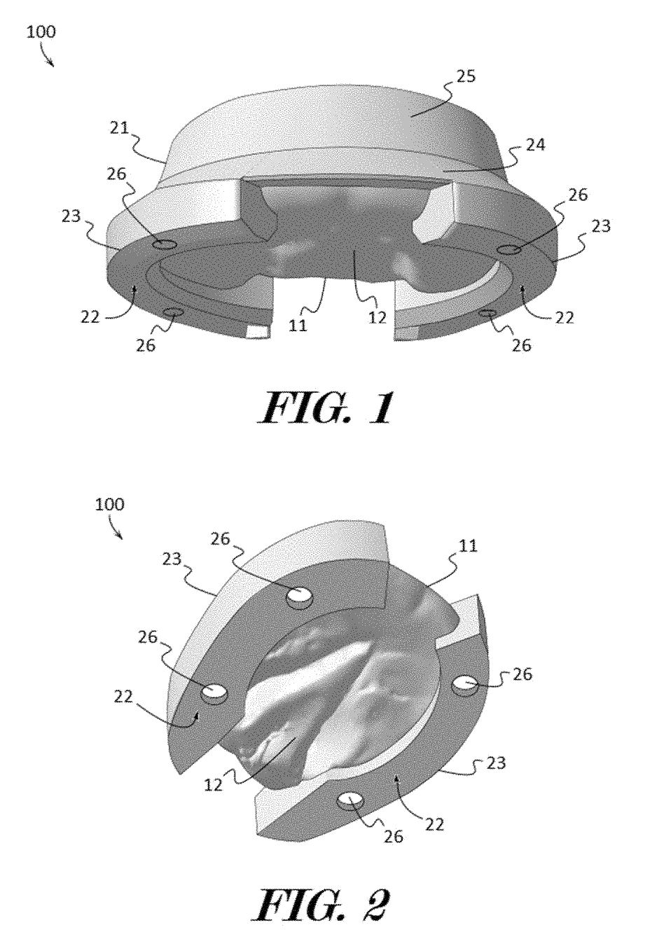

For purposes of description herein, the terms “upper”, “lower”, “left”, “right”, “rear”, “front”, “side”, “vertical”, “horizontal”, and derivatives thereof may relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Ungulate foot protection devices and methods are discussed herein. In the following description, for purposes of explanation, numerous specific details are set forth in order to provide a thorough understanding of the present invention. It will be evident, however, to one skilled in the art that the present invention may be practiced without these specific details. The present disclosure is to be considered as an exemplification of the invention, and is not intended to limit the invention to the specific embodiments illustrated by the figures or description below.

The present invention will now be described by example and through referencing the appended figures representing preferred and alternative embodiments.

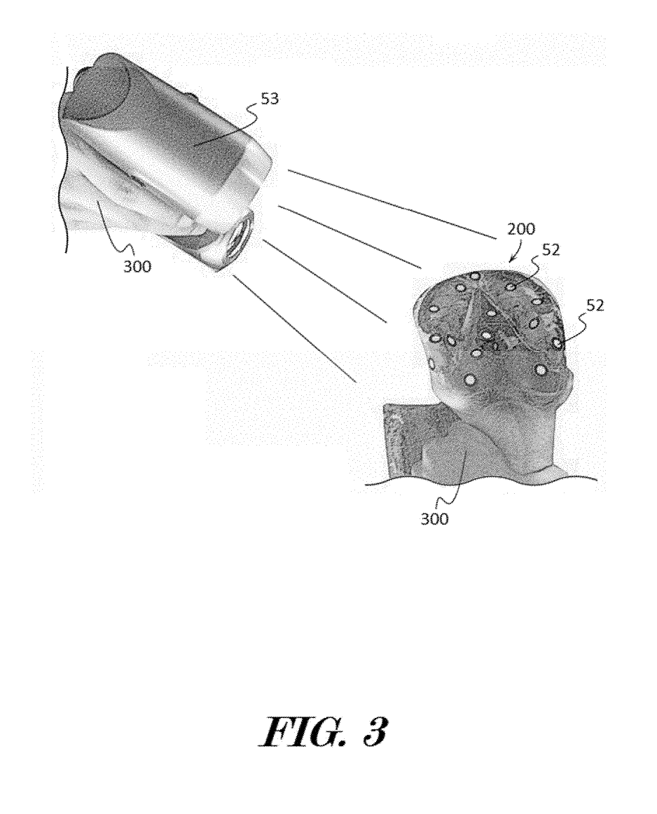

Referring to FIGS. 1 and 2, shown therein and designated by the reference numeral 100 is a first embodiment of the present ungulate foot protection devices. In some embodiments, the device 100 may comprise a foot receiving element 11 coupled to a protective shoe element 21. The foot receiving element 11 may be configured to receive and be coupled to the foot of an animal 200 (FIGS. 3, 6, and 7). The shoe element 21 may be configured to contact the ground surfaces over which an animal wearing the device 100 is to move. The foot receiving element 11 may comprise an overmold of the foot of the animal which is complementary in shape to portions of the foot of the animal thereby allowing all or portions of the foot to be received in the foot receiving element 11. Once the foot is positioned in the foot receiving element 11, all or portions of the foot may be coupled to the foot receiving element 11.

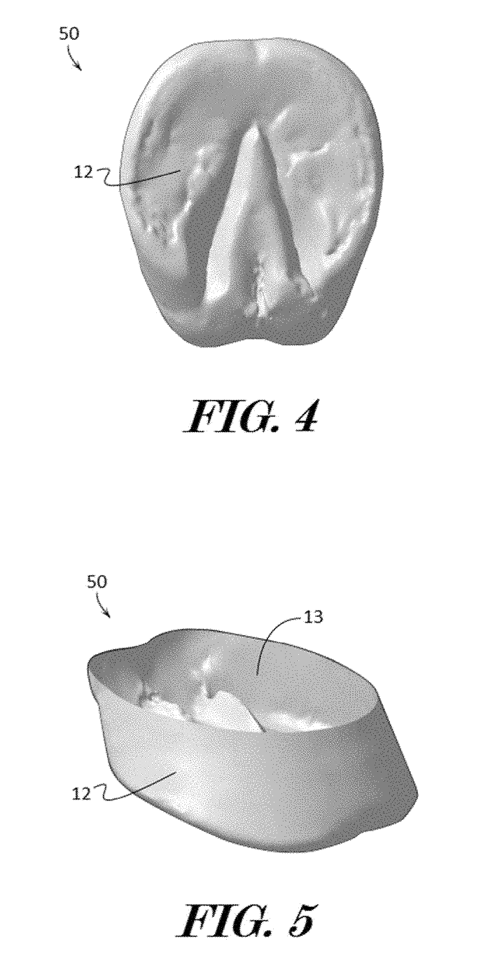

In some embodiments, the foot receiving element 11 may comprise a covering 12 which may be formed as an overmold of all or portions of the foot of an animal 200 (FIGS. 3, 6, and 7). The foot receiving element 11 may also comprise a foot cavity similar in dimensions to the foot cavity 13 of the three-dimensional (3D) image overmold 50 of an animal foot (FIGS. 4 and 5) which may be complementary in shape to the portion of the animal foot 200 which is to be received by the foot receiving element 11. In this manner the foot cavity 13 within the covering 12 forms the overmold of the animal foot 200 which is to be received by the foot receiving element 11.

In some embodiments, the covering 12, which may be formed as an overmold, of the foot receiving element 11 may be coupled to a shoe element 21 which may incorporate a therapeutic design, such as onto one or more shoe walls 23, which can include a heart bar design and a straight bar design. The therapeutic design can be any therapeutic design that is well known in the art that is capable of being produced, preferably by additive manufacturing (e.g., 3D printing). In further embodiments, the covering 12, which may be formed as an overmold, of the foot receiving element 11 may be coupled to a shoe element 21 may be made of translucent silicone or made of any other material that is well known in the art that can formed by a 3D printer. In even further embodiments, the covering 12, which may be formed as an overmold, of the foot receiving element 11 and/or a shoe element 21 may be formed according to the method described in U.S. patent application Ser. No. 12/784,635, filed May 21, 2010, “Mold for an equine hoof and method of making and attaching an in situ horseshoe and hoof protection”, which is commonly owned is and incorporated herein by reference in its entirety.

In some embodiments, the shoe element 21 may comprise one or more ground contacting surfaces 22 which are configured to contact the ground surfaces over which an animal wearing the device 100 is to move. The ground contacting surfaces 22 may be formed on or coupled to one or more shoe walls 23. In the examples of FIGS. 1 and 2, the shoe walls 23 comprise a generally arch shape. In other embodiments, the shoe walls 23 may comprise any other shape or orientation to provide one or more ground contacting surfaces 22 which are suitable for directing the manner in which the shoe element 21 contacts a ground surface. In some embodiments, one or more ground contacting surfaces 22 and/or shoe walls 23 of the shoe element 21 may comprise or be formed with particles of additional material to increase durability and traction (not shown) are added to the injected material. These particles may be formed inside portions of the shoe element 21 and/or portions of the covering 12, which may be formed as an overmold, of the foot receiving element 11. The particles can include tungsten granules and dust and carbide granules and dust, but can include other particles that increase the durability and traction of horseshoes and like hoof protection devices that are well known in the art. A stud thread (not shown) can also be added or formed into the foot receiving element 11 and/or shoe element 21 optionally before and during application of an adhesive material that may be applied to portions of the animal foot 200 within the covering 12 and to the covering 12 to couple the foot receiving element 11 to the animal foot 200. In still further embodiments, a plurality of inserts of any suitable material to increase durability (not shown) can also be placed or coupled in or to the shoe element 21 and/or portions of the covering 12, which may be formed as an overmold, of the foot receiving element 11 optionally before applying the injected adhesive material.

In further embodiments, the shoe element 21 may comprise one or more foot sidewalls, such as a lower foot sidewall 24 and/or an upper foot sidewall 25 which may be configured to provide structural support to all or portions of the covering 12 of the foot receiving element 11. A lower foot sidewall 24 may reinforce portions of the covering 12 proximate to a shoe wall 23 and may optionally be coupled to a shoe wall 23 and/or an upper foot sidewall 25. An upper foot sidewall 25 may reinforce portions of the covering 12 more distant from the shoe wall 23 and may optionally be coupled to a shoe wall 23 and/or lower foot sidewall 24.

In some embodiments, the device 100 may comprise one or more apertures 26 which may be configured to pass through the shoe element 21 and/or the foot receiving element

11. In preferred embodiments, the apertures 26 may be spaced and sized to allow a substance, such as, for example, an adhesive material, to be inserted or injected into the foot cavity 13 of the covering 12. By placing the foot of an animal 200 (FIGS. 3, 6, and 7) within the foot cavity 13 of the covering 12 and by injecting or inserting adhesive material through one or more apertures 26 the adhesive material may be applied to portions of the animal foot 200 within the covering 12 and to the covering 12 to couple the foot receiving element 11 to the animal foot 200. In further embodiments, the injected adhesive material may comprise a two part plastic or urethane and adhesive material which preferably may be configured to set and cure in a range of 1 to 5 minutes. The injected adhesive material can be any two part plastic or urethane and adhesive material that is well known to those schooled in the art. In some embodiments, the injected adhesive material can include a thermosetting molding material such as, for example, a thermosetting polymer (e.g., polyurethane and/or the like, silicone such as, for example, liquid silicone rubber, and/or the like). In some further embodiments, the injected adhesive material can include a thermoplastic molding material such as, for example, polypropylene, low-density polyethylene, polystyrene, polycarbonate, and/or the like. Such materials used in the injected adhesive material may be configured to be degassed by, for example, a vacuum-casting machine.

The injected material may be injected by any suitable material injection or application gun that is known in the art, but the mold and method is not limited to the use of an injection gun to inject the adhesive material into the cavity 13 of the overmold of the foot receiving element 11. In alternative embodiments, an aperture 26 may be sized and shaped to allow any other suitable coupling method to be used to couple an animal foot 200 to the foot receiving element 11.

FIG. 3 shows a perspective view of an example of recording a digital image of the foot of an animal 200 (FIGS. 3, 6, and 7) according to various embodiments described herein. In some embodiments, the overmold of the animal foot 200 may be formed using a 3D scanner 53, such as a hand-held laser scanner, which is able to create a digital 3D image of the animal foot

Optionally, the 3D scanner 53 may be held in the hand 300 of a user while the foot of the animal is maintained in position by the hand 300 of the same or other user. In further embodiments, one or more reference features 301, such as adhesive reflective tabs, may be positioned on the animal foot 200 being scanned to facilitate in the creation of the digital 3D image of the animal foot 200. By recording the 3D measurements of the animal foot 200, an overmold may be created which is slightly larger and complementary in shape to the animal foot. This overmold may be formed as the cavity 13 of the foot receiving element 11 thereby allowing the cavity 13 to provide a glove-like fit on the foot of the animal 200.

FIGS. 4 and 5 depict an example of a 3D image overmold 50 of an animal foot 200 (FIGS. 3, 6, and 7) according to various embodiments described herein. In this example, the 3D image overmold 50 is configured to cover the lower portion of a horse hoof. The 3D image overmold 50 may comprise a digital foot cavity 13 formed into a digital covering. The 3D image overmold 50 may be converted into a physical form to create the foot receiving element 11 with a cavity and covering 12 which may be used to receive portions of the scanned animal foot 200.

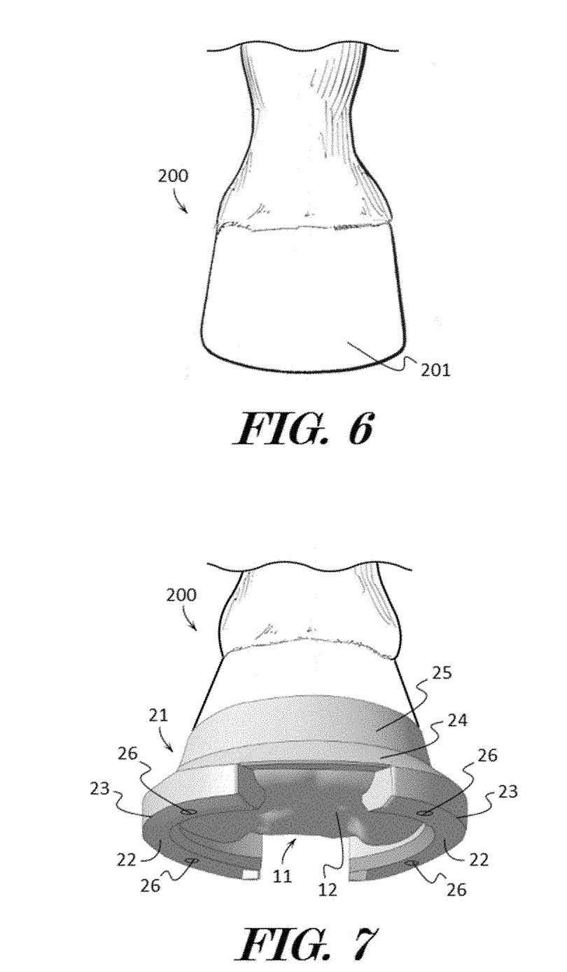

In preferred embodiments, 3D image overmold 50 is a digital representation of the foot receiving element 11 so that the digital foot cavity 13 and digital covering 12 are the digital equivalent to the foot cavity 13 and covering 12 of the real-world or physical foot receiving element 11. FIG. 6 shows an elevation view of an example of the foot of an animal 200 and FIG. 7 depicts a front bottom perspective view of an example of an ungulate foot protection device 100 coupled to the foot of an animal 200 according to various embodiments described herein. In this example, the ungulate foot is a horse hoof although the method and devices described herein may be used with camels, domestic cattle, other bovinae, or any other ungulate animal. The lower portion 201 of the animal foot 200 or hoof is shown received in the foot receiving element 11. By forming the covering 12 and foot cavity 13 into an overmold of the lower portion 201 of the animal foot 200, the foot receiving element 11 may comprise a glove-like fit to the animal foot 200. In preferred embodiments, an adhesive material may be inserted into one or more apertures 26 to couple the animal foot 200 to the foot receiving element 11.

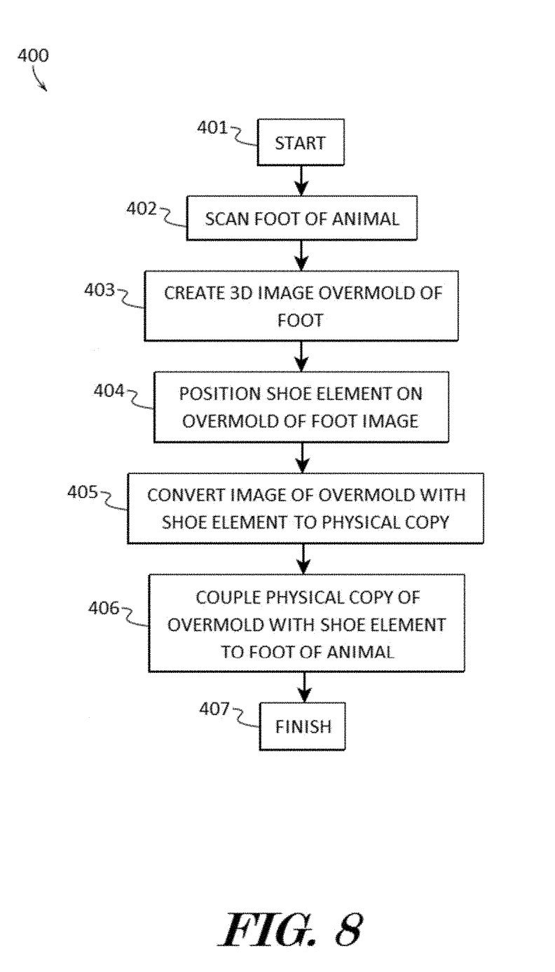

FIG. 8 illustrates a block diagram of an example of an ungulate foot protection method (“the method”) 400 according to various embodiments described herein. In some embodiments, the method 400 may be used to provide foot protection to an ungulate, such as a horse, mule, donkey, camel, pigs, cattle, or any other terrestrial ungulate. In further embodiments, the method 400 may be used to provide foot protection to an ungulate by forming an ungulate foot protection device 100 (FIGS. 1, 2, and 6) which may be secured to the foot of an animal 200 (FIGS. 3, 6, and 7) thereby providing protection to the foot of an animal 200. In some embodiments, the method 400 may start 401 and the foot of an animal 200 may be scanned in step 402. In further embodiments, the animal foot 200 may be scanned by a 3D scanner 53 (FIG. 3) such as a hand-held laser scanner or any other suitable scanning device. By scanning the animal foot 200, the exact measurements and dimensions of the animal foot 200 may be recorded. Optionally, one or more reference features 301 (FIG. 3), such as adhesive reflective tabs, may be positioned on the animal foot 200 being scanned. In this way and others, a 3D image of a portion of the ungulate foot is captured.

Next, in step 403 a 3D image of an overmold (e.g., 50) of the animal foot 200 may be produced. Using the recorded 3D measurements of the animal foot 200 obtained in step 402, a digital overmold may be created comprising a cavity 13 that is slightly larger and complementary in shape to the animal foot. Generally, overmold 50 includes a cavity (e.g., 13) that is complementary in shape to (e.g., substantially matches a negative mold of) the captured 3D image of the portion of the ungulate foot. More specifically, cavity 13 of the digital overmold may comprise a slightly larger, such as between 0.01 to 20 percent larger, negative 3D image of the foot of the animal 200. In some embodiments, a 3D image overmold 50 is a digital representation of the foot receiving element 11 so that the digital foot cavity 13 and digital covering 12 are the digital equivalent to the foot cavity 13 and covering 12 of the real-world or physical foot receiving element 11.

In step 404, a 3D image of protective shoe element 21 may be assembled with the 3D image of overmold 50. For example, the 3D image of shoe element 21 (FIGS. 1, 2, 6) may be positioned on the 3D image of overmold 50 to form a digital copy of the device 100. A digital shoe element 21 comprising one or more ground contacting surfaces 22 may be added to the 3D image and digitally coupled to the overmold which will form the foot receiving element 11. In some embodiments, the shoe element 21 may comprise one or more shoe walls 23 onto which the contacting surfaces 22 may be formed or coupled. In further embodiments, the shoe element 21 may comprise one or more lower foot sidewalls 24 and/or upper foot sidewalls 25. In this manner a digital copy of an ungulate foot protection device 100 may be created. In preferred embodiments, one or more apertures 26 may be positioned anywhere on the device 100 which may be configured to pass through the shoe element 21 and/or the foot receiving element 11.

Next in step 405, the assembled 3D images of shoe element 21 and overmold 50 may be manufactured. More specifically, the 3D image of overmold 50 and the 3D image of shoe element 21 may be converted to a physical copy of the digital ungulate foot protection device 100, created in step 404, thereby comprising a foot receiving element 11 and a shoe element 21. In preferred embodiments, manufacturing the assembled 3D images of shoe element 21 and overmold 50 includes converting the assembled 3D images into physical form by additive manufacturing (e.g., 3D printing). In some embodiments, the method 400 may use extrusion 3D printing with materials such as thermoplastics, eutectic metals, edible materials, rubbers, modeling clay, plasticine, metal clay (including precious metal clay), ceramic materials, metal alloy, cermet, metal matrix composite, ceramic matrix composite. In further embodiments, the method 400 may use light polymerized 3D printing with any suitable photopolymer. In further embodiments, the method 400 may use powder bed 3D printing with materials such as any suitable metal alloy, including Titanium alloys, Titanium alloys, Cobalt Chrome alloys, Stainless Steel, Aluminum, powdered polymers, Plaster, including Titanium alloys, Thermoplastic powder, Thermoplastics, metal powders, and ceramic powders.

In alternative embodiments, any other suitable method for converting a 3D image into a physical copy may be used to convert the image of the overmold with shoe element to a physical copy of the device 100. In further embodiments, all or portions of the foot receiving element 11 and a shoe element 21 may be made from or comprise durable materials such as hard plastics, including nylon, acrylic, uPVC, HDPE, melamine, metals and metal alloys, wood, hard rubbers, carbon fiber, fiber glass, resins, such as epoxy resin, polymers or any other suitable materials including combinations of materials. Additionally, one or more elements may be made from or comprise durable and slightly flexible materials such as soft plastics, silicone, soft rubbers, fabrics, or any other suitable materials including combinations of materials.

In some embodiments, one or more of the elements that comprise the device 100 may be coupled or connected together with heat bonding, chemical bonding, adhesive materials, clasp type fasteners, clip type fasteners, rivet type fasteners, threaded type fasteners, other types of fasteners, or any other suitable joining method. In other embodiments, one or more of the elements that comprise the device 100 (e.g., foot receiving element 11 and/or shoe element 21) may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

In even further embodiments, particles of additional material to increase durability and traction (not shown) may be added to a material and/or coupled to an element used to form the device 100. The particles can include tungsten granules and dust and carbide granules and dust, but can include other particles that increase the durability and traction of a ground contacting surface 22 or other element of the device 100. In even further embodiments, one or more apertures 26 may be positioned anywhere on the device 100 which may be configured to pass through the shoe element 21 and/or the foot receiving element 11 after the physical copy of the device 100 is made. The apertures 26 may be made by drilling or any other suitable method of creating an aperture 26.

In step 406, the physical copy of the foot receiving element 11 with shoe element 21, forming the physical ungulate foot protection device 100 may be coupled to the foot of the animal 200. More specifically, overmold 50 (e.g., manufactured) may be coupled to an ungulate foot (e.g., 200). In some embodiments, the foot protection device 100 may be coupled to an animal foot 200 by applying an adhesive material, such as Bisphenol A epoxy resin, Bisphenol F epoxy resin, Novolac epoxy resin, Aliphatic epoxy resin, Glycidylamine epoxy resin, other Multi-part adhesive materials, Cyanoacrylates, solvent-based adhesive materials, polymer dispersion adhesive materials, Contact adhesive materials, Hot adhesive materials, One-part adhesive materials, or any other suitable adhesive material, within the foot cavity 13 of the shoe element 21 and then inserting the foot of the animal 200 into the foot cavity 13 so that the adhesive material may couple the device 100 to the animal's foot 200. In other embodiments, the foot protection device 100 may be coupled to an animal foot 200 by applying adhesive material within the foot cavity 13 and/or to the animal's foot 200 and then inserting the foot of the animal 200 into the foot cavity 13 so that the adhesive material may couple the device 100 to the animal's foot 200. In preferred embodiments, the foot of the animal 200 may be inserted or received within the foot cavity 13 of the device 100 and then an adhesive material may be injected through one or more apertures 26 to couple the device 100 and animal foot together. In alternative embodiments, the device 100 may be coupled to the foot of an animal 200 with heat bonding, chemical bonding, clasp type fasteners, clip type fasteners, rivet type fasteners, threaded type fasteners, other types of fasteners, or any other suitable joining method. Once the device 100 is coupled to the foot of an animal 200, the method 400 may finish 407.

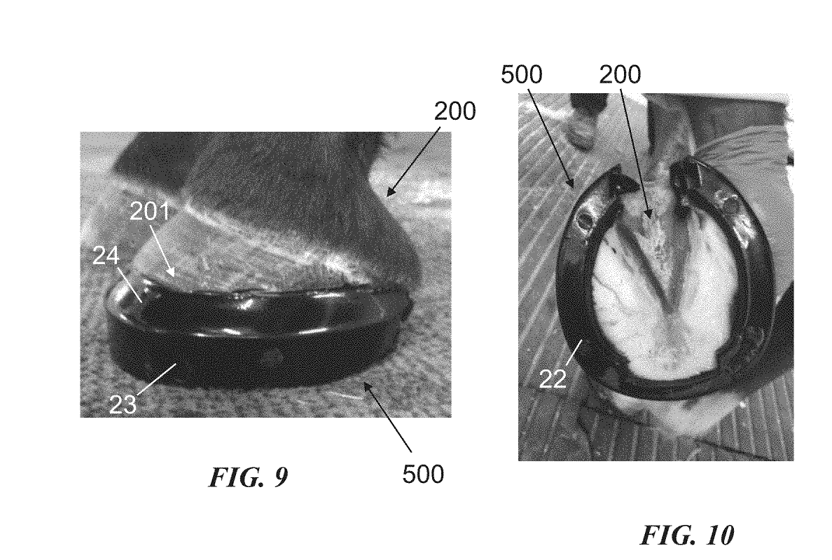

Referring now to FIGS. 9 and 10, shown therein and designated by the reference numeral 500 is a second embodiment of the present protection devices. Device 500 is substantially similar to device 100, with the primary exception that device 500 does not include a bottom portion of covering 12. As shown, device 500 includes shoe wall 23, lower sidewall 24, and ground contacting surface 22. Device 500 includes a protective material that tends to solidify over time. Such protective materials may include a thermosetting polymer (e.g., polyurethane and/or the like).

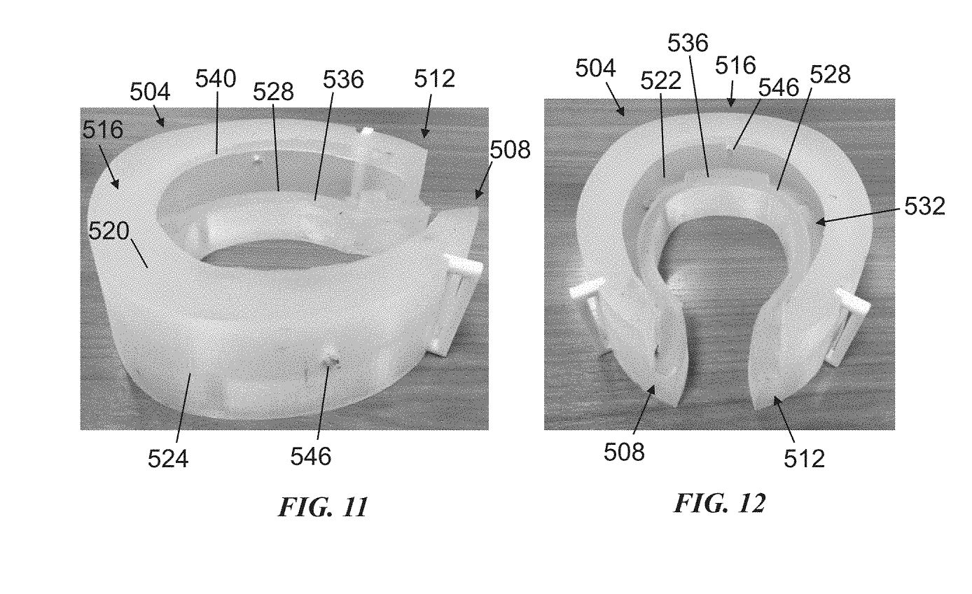

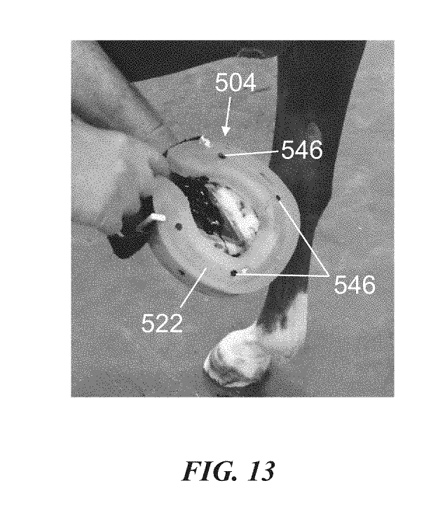

Referring now to FIGS. 11-13, shown therein and designated by the reference numeral 504 is an embodiment of a mold configured to, at least in part, produce some embodiments of the present protection devices. Mold 504 may be configured to be coupled to an ungulate foot (e.g., 200), as shown, for example, in FIG. 13, to produce some embodiments of the present protection devices.

In this embodiment, mold 504 may be generally horseshoe-shaped. For example, mold 504 may include a first end 508, a second end 512, and a curved portion 516 between the first end and the second end. In this embodiment, mold 504 includes a top wall 520, a bottom wall 522, and a sidewall 524 extending between the top wall and the bottom wall. In the depicted embodiment, mold 504 includes a protrusion 528 extending from bottom wall 522 toward top wall 520. For example, protrusion 528 extends from bottom wall 522 such that the protrusion, the bottom wall, and sidewall 524 cooperate to define a channel 532 extending along curved portion 516 (e.g., between first end 508 and second end 512 of mold 504). In this embodiment, protrusion 528 includes an upper surface 536. Upper surface 536 can be configured to correspond to (e.g., substantially match a negative mold of) a bottom surface of an ungulate foot (e.g., 200) such that, when mold 504 is coupled to the foot, a majority (e.g., such as all) of the upper surface of the protrusion is in contact with the bottom surface of the foot. Top wall 520 of mold 504 includes an inner surface 540 that is configured to correspond to (e.g., substantially match a negative mold of) a perimeter of a portion of an ungulate foot (e.g., 200) such that, when the mold is coupled to the foot, a majority (e.g., such as all) of the inner surface of the top wall is in contact with the portion of the foot (e.g., lower portion 201 of the foot).

In this embodiment, at least a portion of mold 504 may be flexible and/or resilient such that, for example, first end 508 and second end 512 of the mold can be moved relative to one another (e.g., moved in opposite directions) to allow an ungulate foot (e.g., 200) to contact inner surface 540 of top wall 520 and/or upper surface 536 of protrusion 528, thereby coupling the mold to the foot. In some embodiments, a mold (e.g., 504) can include a hinge to move a first end (e.g., 508) and a second end (e.g., 512) of the mold relative to one another to couple the mold to an ungulate foot (e.g., 200).

Mold 504 may include one or more openings 546 configured to allow a protective material to be disposed onto an ungulate foot (e.g., 200) when the mold is coupled to the foot. More specifically, in this embodiment, top wall 520, bottom wall 522, and/or sidewall 524 can include one or more openings 546 sized to allow an injection device (e.g., material injection and/or application gun, as described herein) to inject a protective material between an ungulate foot (e.g., 200) and mold 504 when the mold is coupled to the foot. For example, protective material may be injected (e.g., via a handheld gun) through one or more openings 546 such that the protective material occupies a majority (e.g., including all) of the volume between mold 504 and an ungulate foot (e.g., 200). In some embodiments, protective material may include a topical medication (e.g., cream, ointment, gel, foam, and/or the like) that may be injected through one or more openings (e.g., 546) and/or applied to an ungulate foot (e.g., 200) before coupling mold 504 to the foot. Such topical medications may be configured to treat ailments tending to affect ungulate feet, such as, for example, laminitis. One example of a suitable topical medication for treating laminitis includes Laminil®, which is commercially available and supplied by Willowcroft Pharm, Inc. of Denver, Colo.

Mold 504 may be configured to minimize leakage of protective material during injection of the protective material between the mold and an ungulate foot (e.g., 200). For example, by providing inner surface 540 and upper surface 536, one or both of which correspond in shape to an ungulate foot (e.g., 200) and are configured to contact the foot, leakage of protective material is minimized. In some embodiments, inner surface 540 and/or upper surface 536 of mold 504 may be urged into contact with an ungulate foot (e.g., 200) by, for example, securing movement of first end 508 and second end 512 of the mold relative to one another. For example, movement of first end 508 and second end 512 may be secured relative to one another by coupling the first end to the second end with a fastener (e.g., clasp-type fastener, clip-type fastener, rivet-type fastener, threaded-type fastener, hook and loop-type fastener (e.g., Velcro®), snap-type fastener, ratchet-type fastener, and/or the like), an interlocking joint (e.g., press fit, snap fit, tongue and groove joint, and/or the like), one or more magnets, a push-to-lock connection, a turn-to-lock connection, a slide-to-lock connection, and/or the like. In this way and others, mold 504 may be releasably secured to an ungulate foot (e.g., 200) such that the mold remains coupled to the foot during injection of the protective material. In some embodiments, a first end (e.g., 508) and a second end (e.g., 512) of a mold (e.g., 504) are integrally formed (e.g., unitary) with one another.

At least a portion of mold 504 may include a material that is translucent. In this embodiment, mold 504 can comprise a material that tends to solidify over time. Such materials may include a thermosetting molding material such as, for example, a thermosetting polymer (e.g., polyurethane and/or the like, silicone such as, for example, liquid silicone rubber, and/or the like). In some embodiments, a mold (e.g., 504) can comprise a material that includes a thermoplastic molding material such as, for example, polypropylene, low-density polyethylene, polystyrene, polycarbonate, and/or the like. Mold 504 may include a non-porous material. For example, materials used to make mold 504 may be configured to be degassed by, for example, a vacuum-casting machine.

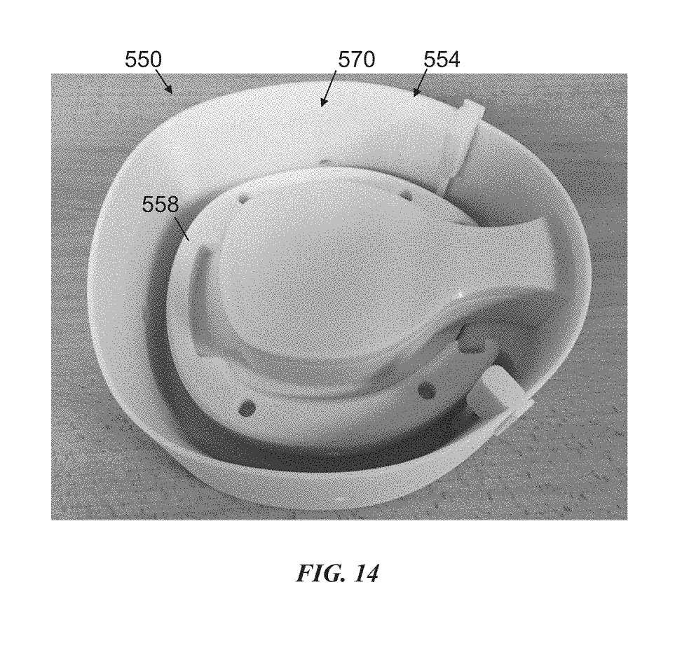

Referring now to FIG. 14, shown therein and designated by the reference numeral 550 is an embodiment of an assembly configured to, at least in part, produce some embodiments of the present molds.

Assembly 550 comprises a casing 554 and a mold pattern 558. Mold pattern 558 is configured to be removably disposable within casing 554. In this embodiment, when mold pattern 558 is located within casing 554, the mold pattern and the casing cooperate to define a volume whose shape is characterized by the shape of mold 504.

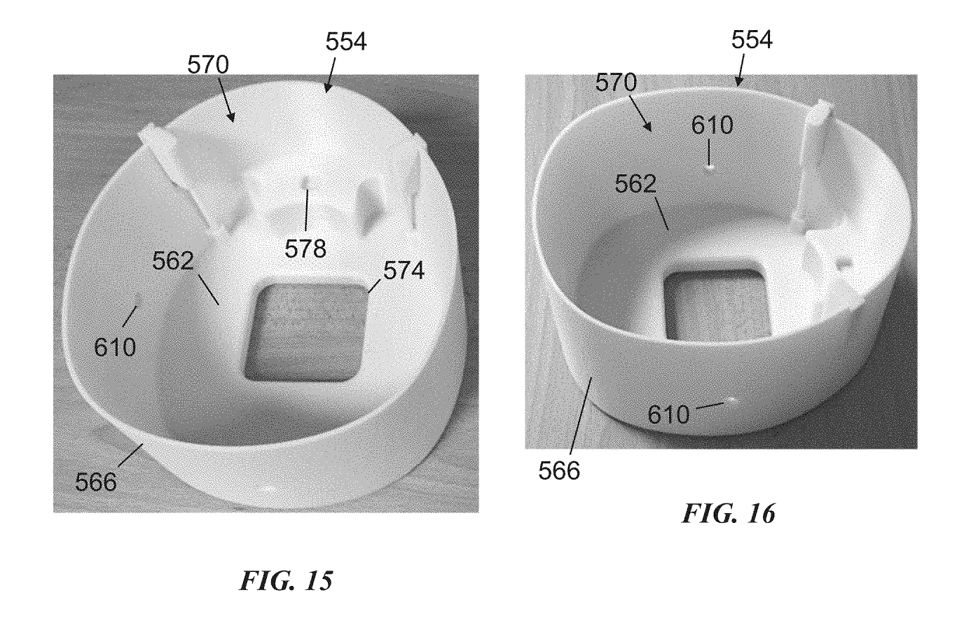

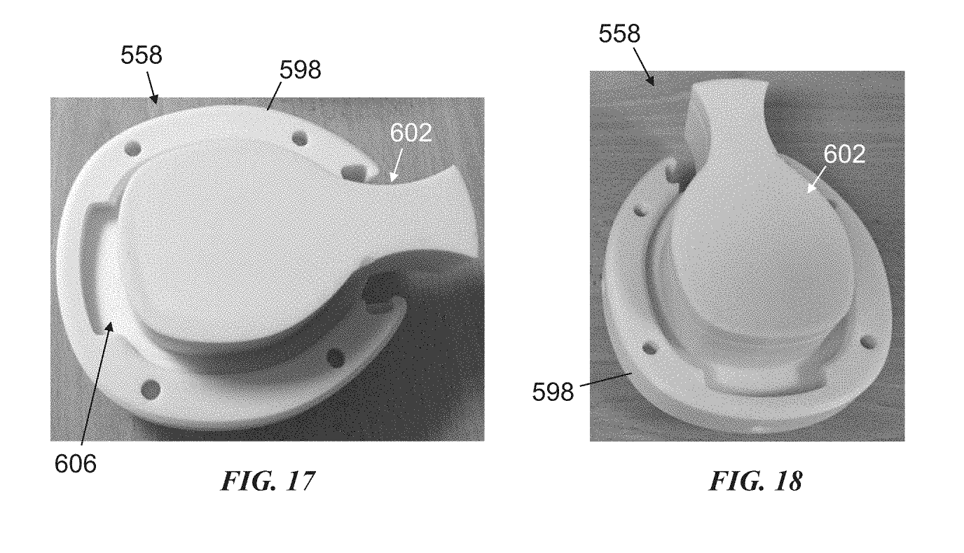

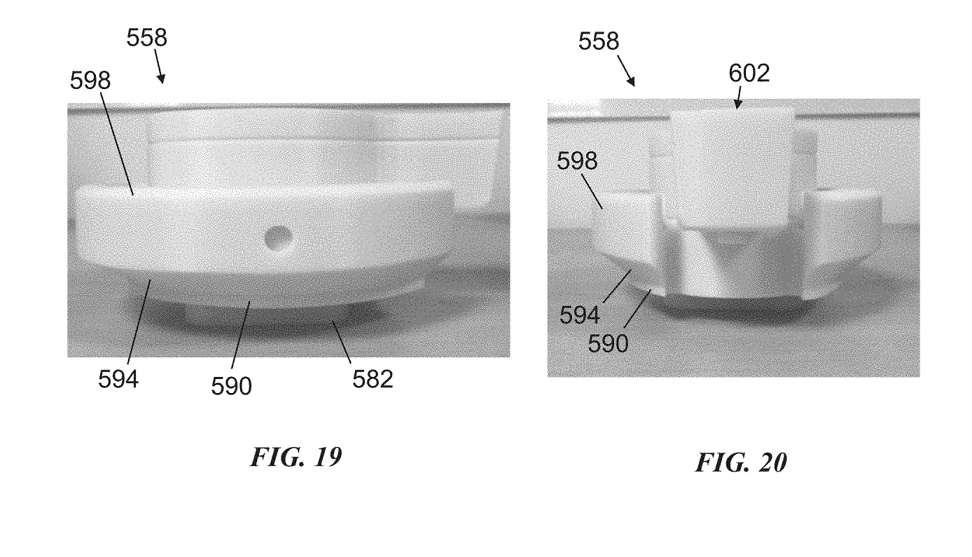

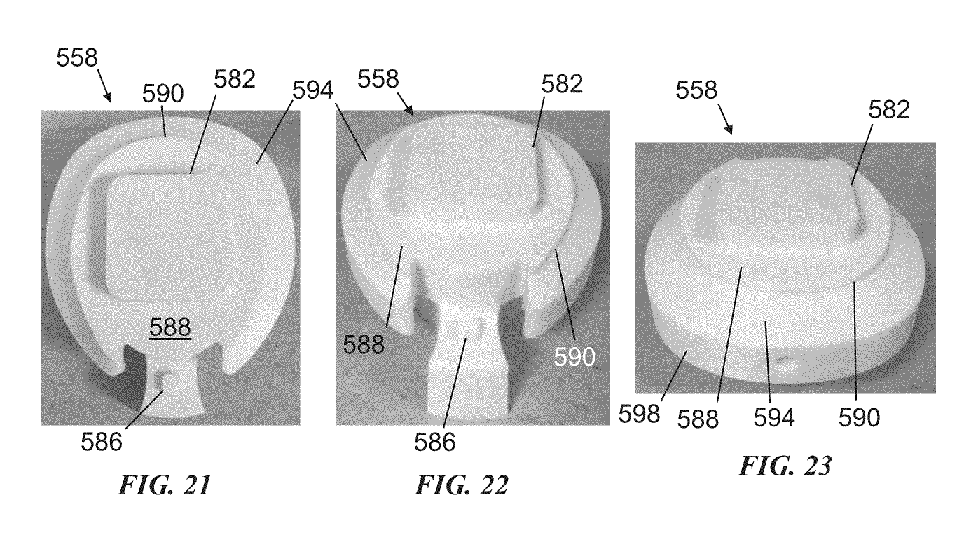

In this embodiment, casing 554 includes a bottom wall 562 and a sidewall 566 that cooperate to define a cavity 570 (e.g., FIGS. 14-16). In the depicted embodiment, bottom wall 562 of casing 554 includes a first recess 574, such as, for example, an opening, and a second recess 578, each of which correspond to a first protrusion 582 and a second protrusion 586, respectively, of mold pattern 558. First protrusion 582 and second protrusion 586 of mold pattern 558 may at least partially extend into first recess 574 and second recess 578, respectively, of casing 554 to locate (e.g., center) the mold cavity within cavity 570 of the casing.

Mold pattern 558 includes a surface 588 having an outer edge 590 that corresponds (e.g., matches) in shape to a 3D image of an ungulate foot (e.g., 200). Such 3D images of an ungulate foot (e.g., 200) may be captured using one or more of the techniques described above. Outer edge 590 of surface 588 may substantially match at least a portion of a perimeter of an ungulate foot 200 (e.g., a portion of a perimeter of lower portion 201). For example, when mold 504 is produced using assembly 500, inner surface 540 of top wall 520 of the mold corresponds to (e.g., matches a negative mold of) outer edge 590 of mold pattern 558. As such, when protective device 500 is produced using mold 504, the protective device is customized to fit onto the particular ungulate foot (e.g., 200) that has been imaged.

Mold pattern 558 includes a sloped surface 594 extending between outer edge 590 and an outer ridge 598. Sloped surface 594 and outer ridge 598 of mold pattern 558 may cooperate to define channel 532 of mold 504 when the mold is produced using assembly 500. As shown, outer ridge 598 and a center portion 602 of mold pattern 558 may cooperate to define a channel 606 therebetween. Channel 606 of mold pattern 558 corresponds to upper surface 536 of mold 504 when the mold is produced using assembly 500.

Sidewall 566 of casing 554 includes one or more openings 610 extending through the sidewall. Assembly 500 may include one or more pins configured to be disposed through respective openings in casing 554. Such pins may define one or more openings 546 in mold 504 when the mold is produced using assembly 500.

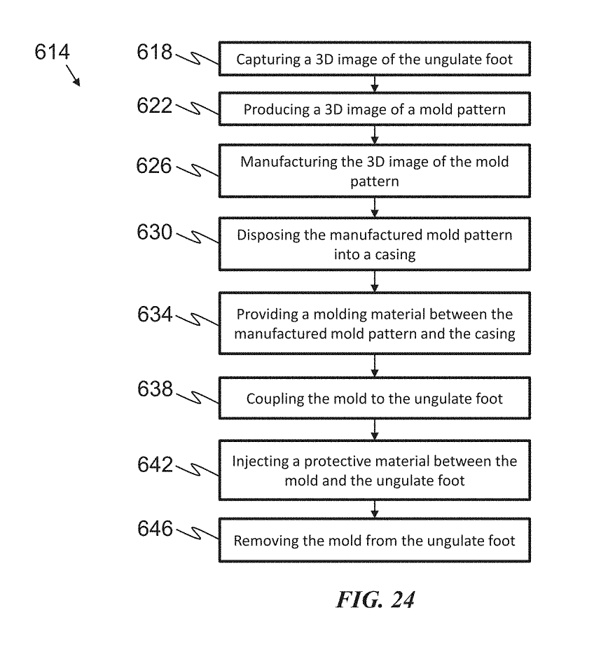

FIG. 24 depicts an embodiment of the present methods for protecting an ungulate foot (e.g., 200). Method 614 can be implemented, in part or in whole, using assembly 500.

At step 618, a 3D image of a portion of an ungulate foot (e.g., 200) is captured using one or more of the techniques described herein. At step 622, a 3D image of mold pattern 558 may be produced, according to the 3D image of the portion of the ungulate foot. For example, mold pattern 558 may be produced such that outer edge 590 corresponds in shape to (e.g., substantially matches) the 3D image of the portion of the ungulate foot captured in step 618. Next, in step 626, the 3D image of mold pattern 558 may be manufactured by, for example, by any suitable additive manufacturing process (e.g., electron-beam melting (EBM), electron beam freeform fabrication (EFB³), fused filament fabrication (FFF), directed energy deposition (DED), direct ink writing (DIW), digital light processing (DLP), direct metal laser sintering (DMLS), laminated object manufacturing (LOM), selective heat sintering (SHS), stereolithography (SLA), selective laser melting (SLM), selective laser sintering (SLS), powder bed and inkjet head 3D printing (3DP), and/or the like) and/or subtractive manufacturing (e.g., a mill, lathe, drill, and/or the like, one or more of which can be controlled by a computer numeric control (CNC)).

At step 630, mold pattern 558 may be disposed into casing 554. For example, first protrusion 582 and second protrusion 586 of mold pattern 558 may be at least partially inserted into first recess 574 and second recess 578 of casing 554 in order to appropriately position (e.g., center) the mold pattern in the casing. Next, at step 634, a molding material (as described herein) may be provided (e.g., poured) between mold pattern 558 and casing 554 such that, after a first amount of time (e.g., sufficient for the molding material to cure), the molding material is capable of hardening into mold 504 (e.g., due to properties of the molding material), which replicates a volume between the mold pattern and the casing. Such a molding material may be degassed (e.g., by a vacuum-casting machine) before and/or after it is provided between mold pattern 558 and casing 554. At step 638, mold 504 may be coupled to the ungulate foot (e.g., 200), as described herein. One or more straps and/or clamps may be used to securely couple mold 504 to the ungulate foot (e.g., 200). Next, at step 642, a protective material is injected through one or more openings 546 extending through mold 504. After a second amount of time (e.g., sufficient for the protective material to cure), mold 504 is removed from the ungulate foot (e.g., 200), thereby leaving behind protective device 500 that is coupled to the ungulate foot (e.g., 200).

Some embodiments of the present methods (e.g., 614) of protecting an ungulate foot (e.g., 200), comprise: capturing a three-dimensional image of a portion (e.g., 201) of the ungulate foot; producing a three-dimensional image of a mold pattern (e.g., 558), wherein the mold pattern includes a surface (e.g., 588, 590) that corresponds in shape to the captured three-dimensional image of the portion of the ungulate foot; manufacturing the three-dimensional image of the mold pattern; disposing the manufactured mold pattern into a casing (e.g., 554); and providing a molding material having silicone between the manufactured mold pattern and the casing, wherein the molding material includes properties such that, after a first amount of time, the molding material is capable of hardening into a solid mold (e.g., 504) that replicates a volume between the manufactured mold pattern and the casing. Some methods comprise coupling the mold to the ungulate foot. Some methods comprise injecting a protective material between the mold and the ungulate foot. Some methods comprise removing the mold from the ungulate foot.

In some methods, the protective material is injected through one or more apertures (e.g., 546) extending through the mold. In some methods, the protective material includes a topical medication.

Some methods comprise degassing the molding material before providing the molding material between the manufactured mold pattern and the casing. Some methods comprise degassing the molding material after providing the molding material between the manufactured mold pattern and the casing. In some methods, the molding material is degassed by a vacuum casting machine.

In some methods, manufacturing the three-dimensional image of the mold pattern includes converting the three-dimensional image into physical form by additive and/or subtractive manufacturing.

In some methods, at least a portion of the mold is translucent. In some methods, the mold is flexible.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A method of protecting an ungulate foot, the method comprising:
capturing a three-dimensional image of a portion of the ungulate foot;
producing a three-dimensional image of an overmold, wherein the overmold includes a cavity that is complementary in shape to the captured three-dimensional image of the portion of the ungulate foot;
assembling a three-dimensional image of a protective shoe element with the three-dimensional image of the overmold; and
manufacturing the assembled three-dimensional images of the protective shoe element and the overmold.

2. The method of claim 1, comprising coupling the manufactured overmold to the ungulate foot.

3. The method of claim 1, wherein manufacturing the assembled three-dimensional images of the protective shoe element and the overmold includes converting the assembled three-dimensional images into physical form by additive manufacturing.

4. The method of claim 1, wherein capturing the three-dimensional image of the portion of the ungulate foot includes scanning the portion of the ungulate foot in three dimensions.

5. The method of claim 2, comprising injecting a substance into the cavity of the manufactured overmold, wherein the substance comprises a thermosetting polymer and/or a polyurethane resin.

6. The method of claim 5, wherein, after coupling the manufactured overmold to the ungulate foot, the substance is injected into the cavity of the manufactured overmold.

7. The method of claim 1, wherein the three-dimensional image of the portion of the ungulate foot is captured by a three-dimensional scanner.

8. A method of protecting an ungulate foot, the method comprising:
capturing a three-dimensional image of a portion of the ungulate foot;
producing a three-dimensional image of a mold pattern, wherein the mold pattern includes a surface that corresponds in shape to the captured three-dimensional image of the portion of the ungulate foot;
manufacturing the three-dimensional image of the mold pattern;
disposing the manufactured mold pattern into a casing;
providing a molding material having silicone between the manufactured mold pattern and the casing, wherein the molding material includes properties such that, after a first amount of time, the molding material is capable of hardening into a solid mold that replicates a volume between the manufactured mold pattern and the casing.

9. The method of claim 8, comprising:
coupling the mold to the ungulate foot;
injecting a protective material between the mold and the ungulate foot; and
removing the mold from the ungulate foot.

10. The method of claim 9, wherein the protective material remains coupled to the ungulate foot after removing the mold from the ungulate foot.

11. The method of claim 9, wherein the protective material is injected through one or more apertures extending through the mold.

12. The method of claim 8, comprising degassing the molding material before providing the molding material between the manufactured mold pattern and the casing.

13. The method of claim 12, comprising degassing the molding material after providing the molding material between the manufactured mold pattern and the casing.

14. The method of claim 8, comprising degassing the molding material after providing the molding material between the manufactured mold pattern and the casing.

15. The method of claim 8, wherein manufacturing the three-dimensional image of the mold pattern includes converting the three-dimensional image into physical form by additive and/or subtractive manufacturing.

16. The method of claim 8, wherein at least a portion of the mold is translucent.

17. The method of claim 8, wherein the mold is flexible.

18. The method of claim 9, wherein the protective material includes a topical medication.

19. An assembly for producing an ungulate foot protection device, the assembly comprising:
a casing having a sidewall and a bottom wall that cooperate to define a cavity;
a mold pattern that is configured to be removably disposed within the cavity of the casing, wherein the mold pattern includes a surface that is configured to correspond in shape to a portion of an ungulate foot.

20. The assembly of claim 19, comprising a molding material configured to be disposed in the cavity between the casing and the mold pattern, wherein the molding material includes silicone.
